(19) United States
(12) Patent Application Publication
(10) Pub. No.: US 2009/0035625 A1
(43) Pub. Date: Feb. 5, 2009

(54) HYDROGEN FUEL CELL WITH INTEGRATED REFORMER

(76) Inventor: Tihiro Ohkawa, La Jolla, CA (US)

Correspondence Address: NYDEGGER & ASSOCIATES, 348 OLIVE STREET, SAN DIEGO, CA, 92103, US

(21) Appl. No.: 11/832,374

(22) Filed: Aug. 1, 2007

(51) Int. Cl. H01M 8/06

(52) U.S. Cl. 429/19; 429/12

(57) ABSTRACT

A unit for generating an electrical current includes an electrolysis cell and a hydrogen fuel cell having a common mid-electrode. This mid-electrode is hydrophobic and separates a PEM electrolyte in the fuel cell from an electrolyte mixture of water and a carbon compound in the electrolysis cell. Electrolysis of the water produces hydrogen at the mid-electrode and carbon dioxide at the anode of the unit. The hydrogen diffuses into the hydrogen fuel cell through the mid-electrode but it prevents the water mixture in the electrolysis cell from contacting the PEM electrolyte in the fuel cell. Oxygen is provided to react with hydrogen protons at the cathode of the fuel cell to produce water. An external circuit is provided between the respective unit anode at the electrolysis cell and the unit cathode at the fuel cell for carrying the electrical current generated by the unit.

### FIELD OF THE INVENTION

The present invention pertains generally to fuel cells. More particularly, the present invention pertains to hydrogen fuel cells that are assisted by a reforming unit. The present invention is particularly, but not exclusively, useful as an integrated unit wherein an electrolysis cell is structurally integrated, directly with a hydrogen fuel cell for generating electricity.

### BACKGROUND OF THE INVENTION

The basic operation of a hydrogen fuel cell is well known. Specifically, in a hydrogen fuel cell, hydrogen is directed to the anode on one side of the cell, while oxygen is directed to the cathode on the other side of the cell. At the anode, the hydrogen is split into hydrogen ions (protons) and electrons. An electrolyte, such as a Proton Exchange Membrane (PEM) allows only the protons to pass through the electrolyte to the cathode. Consequently, the electrons are directed along an external circuit to the cathode, creating an electrical current. At the cathode, electrons from the electrical current combine with protons in the electrolyte, and with oxygen from an external source, to form water. Hydrogen gas, however, is not a convenient fuel for mobile or portable power sources. On the other hand, liquid fuels such as methanol or ethanol are much more suitable for such applications.

An example of a fuel cell that uses a carbon compound fuel (i.e. methanol) is the Direct Methanol Fuel Cell (DMFC). In its operation, a DMFC oxidizes the methanol to generate electrical power. Electrolytes, however, such as PEM that is typically used for a DMFC, are generally incompatible with high concentrations of methanol. Thus, in order to protect the PEM, there is a practical limitation on the concentration of reactant (e.g. methanol) that can be used. And, this is not an insignificant limitation. The consequence is that, DMFCs typically operate at relatively low power densities.

In an attempt to improve the performance of hydrogen fuel cells, the use of carbon compound fuels in a separate, external reformer (reforming unit) has been proposed. In such a system, rather than using an external supply of hydrogen gas, the reformer is used to generate hydrogen for the fuel cell. The separated configuration for the fuel cell and reformer of such a system, however, is cumbersome and somewhat impractical. In any event, insofar as a hydrogen fuel cell is concerned, it is clear that the ability to incorporate a self-generating source of hydrogen is desirable.

With the above in mind, it is well known that hydrogen is produced by the electrolysis of water. Further, it is known that electrolysis is assisted by the oxidation of carbon. The important result here is that when methanol is used for providing carbon, the external energy required for assisted electrolysis is reduced by a factor of 6. Specifically, in assisted electrolysis, the balance of the energy requirement for producing hydrogen from water comes from the oxidation of carbon.

In light of the above, it is an object of the present invention to provide a hydrogen fuel cell and a structurally integrated reforming unit that will operate together, as a single unit, to achieve higher power densities than are otherwise possible with a stand-alone DMFC. Another object of the present invention is to provide a hydrogen fuel cell with an integrated reforming unit that allows for the selection of a fuel from a variety of carbon compounds and isolates the PEM electrolyte of the hydrogen fuel cell from the carbon compound to thereby remove restrictions on carbon compound concentrations. Still another object of the present invention is to provide a hydrogen fuel cell with an integrated reforming unit that will accommodate changes and improvements to the hydrogen fuel cell. Yet another object of the present invention is to provide a hydrogen fuel cell with an integrated reforming unit that is relatively easy to manufacture, is simple to use and is comparatively cost effective.

### SUMMARY OF THE INVENTION

In accordance with the present invention, a hydrogen fuel cell is integrally joined in series with an assisted electrolysis cell to establish a self-contained, power unit. In this combination, the hydrogen fuel cell generally functions as a typical hydrogen fuel cell. On the other hand, the assisted electrolysis cell has a rather unique operation that requires using a mixture containing a carbon compound (e.g. methanol or ethanol).

Structurally, the hydrogen fuel cell and the assisted electrolysis cell of the present invention share a common mid-electrode. Specifically, the arrangement of electrodes for the present invention has the anode of the hydrogen fuel cell joined with the cathode of the electrolysis cell to form the mid-electrode. Thus, the mid-electrode is positioned between the cathode of the fuel cell and the anode of the electrolysis cell. Preferably, the mid-electrode is hydrophobic and porous, and is made of a porous carbon. Further, a source of oxygen gas is provided to direct oxygen onto the cathode of the fuel cell portion of the unit. The electrolyte that is used for the hydrogen fuel cell is preferably a Proton Exchange Membrane (PEM) of a type well known in the pertinent art.

For the assisted electrolysis cell portion of the present invention, an electrolyte is provided between the mid-electrode and its anode that consists of a mixture of water and a carbon compound. Preferably, the carbon compound is either methanol (CH₃OH) or ethanol (C₂H₅OH). Further, the mixture may be either alkaline (e.g. includes sodium hydroxide, KOH) or acidic (e.g. includes sulfuric acid (H₂SO₄). Additionally, an external circuit (e.g. a wire) connects the anode of the electrolysis cell to the cathode of the fuel cell. Thus, electrons generated by the device can be carried as an electrical current by the external circuit.

In the operation of the present invention, the assisted electrolysis cell is considered first. As mentioned above, a mixture of water and a carbon compound is introduced between the mid-electrode and the anode of the electrolysis cell. For example, consider the mixture to be methanol and water: CH₃OH+H₂O. With this mixture, for the case of an alkali electrolyte in the electrolysis cell, the electrolysis reaction at the mid-electrode is: 6H₂O+6e→3H₂+6OH⁻. The hydrogen (H₂) that is produced then passes through the hydrophobic porous cathode and into the hydrogen fuel cell. On the other hand, the hydroxide anions (OH⁻) move to the anode of the electrolysis cell. There, they react with the methanol in the mixture to create carbon dioxide and water in accordance with the following reaction: CH₃OH+6OH⁻→CO₂+5H₂O+6e.

Insofar as the hydrogen fuel cell is concerned, the hydrogen that passes from the electrolysis cell, and through the porous mid-electrode, is ionized in the hydrogen fuel cell to produce hydrogen ions (protons). Specifically, the ionizing reaction at the mid-electrode in the hydrogen fuel cell is: H₂→2H⁺+2e. The resultant protons then move to the cathode of the hydrogen fuel cell where they react with oxygen from the external source in accordance with the following reaction: 2H⁺+[1/2]O₂+2e→H₂O.

With the above in mind, the functions of the mid-electrode can be appreciated. Firstly, the mid-electrode allows electrons that are generated in the fuel cell to pass into the electrolysis cell. Secondly, the mid-electrode allows hydrogen gas that is generated in the electrolysis cell to pass into the hydrogen fuel cell. Thirdly, it separates the electrolyte in the fuel cell (e.g. PEM) and the electrolyte in the electrolysis cell (e.g. methanol) from each other.

In overview, the overall net reaction when methanol is mixed with water is: CH₃OH+[3/2]O₂→2H₂O+CO₂. Using a similar analysis, when ethanol is mixed with water the overall net reaction will be: C₂H₅OH+3O₂→3H₂O+2CO₂. In both instances, regardless which carbon compound is used, it is important to note that the by-products of operation are water and carbon dioxide. Furthermore, it is to be appreciated that the voltage generated in the fuel cell (due to chemical reactions), although in a different direction from the voltage generated in the electrolysis cell, will be approximately six times as great as the voltage consumed in the electrolysis cell (when methanol is used). Expressed notationally: Vₒᵤₜ=V_{[fuel cell]}−V_{[electrolysis cell]}.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an exploded perspective view of the operative components of a fuel cell in accordance with the present invention; and

FIG. 2 is a schematic drawing of the energy producing elements of the present invention.

### DESCRIPTION OF THE PREFERRED EMBODIMENTS

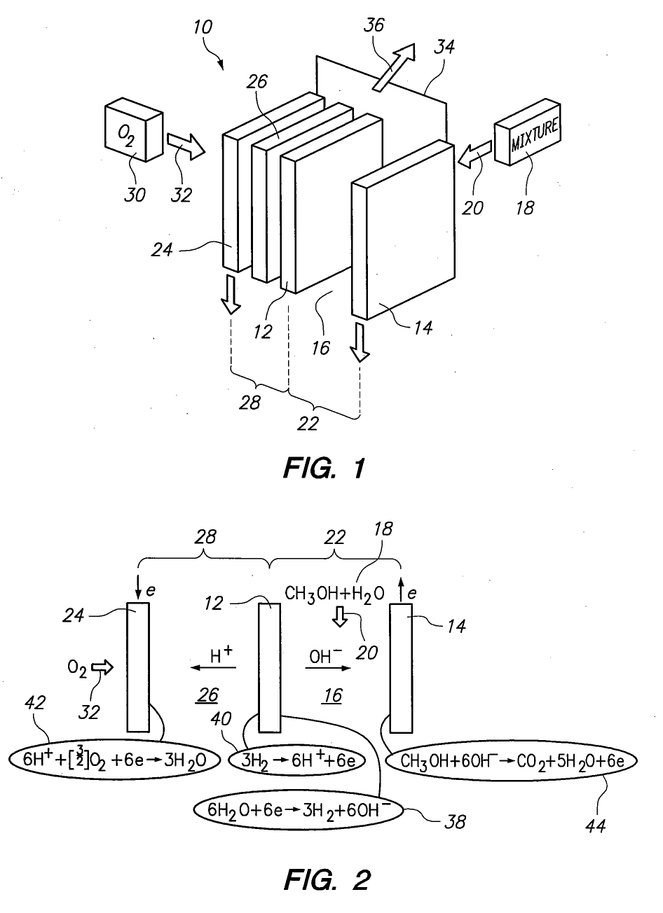

Referring initially to FIG. 1, a power unit in accordance with the present invention is shown and is generally designated 10. As shown, the power unit 10 includes a mid-electrode 12 and an anode 14, with a gap 16 established therebetween. In this combination, the mid-electrode 12 acts as a cathode for an assisted electrolysis cell 22. FIG. 1 also shows that a source is provided to direct a liquid mixture 18 into the gap 16, as indicated by the arrow 20. Together, the mid-electrode 12 and the anode 14, along with the mixture 18, create the assisted electrolysis cell 22. Preferably, the mixture 18 that is used for the present invention is either methanol and water, or ethanol and water. It will be appreciated, however, that other carbon compounds may be used for the present invention. Further, it is important that the mid-electrode 12 be made of a hydrophobic, porous material, such as a porous carbon. Additionally, the anode 14 of the assisted electrolysis cell 22 can be coated with a catalyst or a mixture of catalysts, such as ruthenium (Ru) and platinum (Pt).

FIG. 1 also shows that the unit 10 of the present invention includes a cathode 24, with an electrolyte 26 positioned between the cathode 24 and the mid-electrode 12. In this combination the mid-electrode 12 acts as an anode for a hydrogen fuel cell 28. For the integrated unit 10 of the present invention, the electrolyte 26 in the hydrogen fuel cell 28 is preferably a Proton Exchange Membrane (PEM) of a type well known in the pertinent art. It is also seen in FIG. 1, that a source of oxygen 30 is provided to direct oxygen onto the cathode 24 of the hydrogen fuel cell 28, as indicated by the arrow 32. The unit 10 also includes an external circuit 34 that interconnects the anode 14 of the unit 10 with the cathode 24 of the unit 10. As will be appreciated by the skilled artisan, electrons that are generated by the cells 22 and 28 are carried through the external circuit 34 to generate a power output, indicated by the arrow 36.

Structurally, the unit 10 is configured so that the assisted electrolysis cell 22 and the hydrogen fuel cell 28 share the common mid-electrode 12. Thus, the mid-electrode 12 is preferably a generally flat member. In any event, it is necessary that a carbon compound such as methanol in the assisted electrolysis cell 22 not enter the hydrogen fuel cell 28. Hence, it is necessary the mid-electrode 12 be hydrophobic. On the other hand, in the operation of the unit 10, it is necessary that the hydrogen generated by electrolysis in the assisted electrolysis cell 22 be able to migrate through the mid-electrode 12 for ionization in the hydrogen fuel cell 28.

The various chemical reactions of the unit 10 that provide the electrical current for the external circuit 34 will be best appreciated with reference to FIG. 2. For purposes of this discussion, the mixture 18 that is directed into the gap 16 of the assisted electrolysis cell 22 will be taken to be a mixture of water and methanol (CH₃OH+H₂O). With this in mind, activity at the mid-electrode 12 is considered first.

At the mid-electrode 12, electrolysis of the water in the mixture 18 generates hydrogen gas and hydroxide anions in accordance with the reaction 38 (6H₂O+6e→3H₂+6OH⁻). As indicated above, the hydrogen from this reaction 38 migrates through the mid-electrode 12 for ionization in the hydrogen fuel cell 28 to create protons. This is done in accordance with reaction 40 (3H₂→6H⁺+6e). Consequently, the protons move through the electrolyte (PEM) 26 of the hydrogen fuel cell 28 to the cathode 24. There they react with the oxygen provided by source 30 to generate water in accordance with the reaction 42 (6H⁺+[3/2]O₂+6e [from external circuit 34]→3H₂O). At the same time, for an alkali electrolyte mixture 18, hydroxide anions from the reaction 38 move in the gap 16 toward the anode 14 to react with the methanol in accordance with the reaction 44 (CH₃OH+6OH⁻→CO₂+5H₂O+6e [to external circuit 34]). As shown, a result of the reaction 44 in the assisted electrolysis cell 22 is the generation of carbon dioxide and water. Reaction 44, however, also creates electrons (e) for movement through the external circuit 34 from anode 14 to cathode 24 to generate a power output 36. For the case of an acidic electrolyte, the reaction between the carbon compound and water at the anode 14 produces protons that migrate toward the mid-electrode 12, and electrons which travel from the anode 14 and through the external circuit 34 (see FIG. 1) to the cathode 24.

FIG. 2 illustrates the case where the electrolyte (i.e. mixture 18) in the electrolysis cell 22 is alkaline and the carbon compound is methanol. This is only exemplary as the electrolyte may alternatively be acidic. In the specific case where the electrolyte is alkaline, the electrolysis cell 22 consumes one molecule of water and the fuel cell 28 produces three molecules of water. In this combination, the water management of fuel cells 28 is a well developed art. With this in mind, since the electrolysis cell 22 is a net consumer of water, the carbon compound in mixture 18 of the cell 22 will not leak out into the water management system.

It can be shown that when the mixture 18 includes water and methanol, the overall net reaction of the power unit 10 will be: CH₃OH+[3/2]O₂→2H₂O+CO₂. On the other hand, when the carbon compound in the mixture is ethanol, the overall reaction of power unit 10 will be: C₂H₅OH+3O₂→3H₂O+2CO₂.

While the particular Hydrogen Fuel Cell With Integrated Reformer as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A device for generating an electrical current which comprises:
an anode;
a mid-electrode;
a mixture of water and a carbon compound, wherein the mixture is provided between the mid-electrode and the anode for electrolysis of the water to produce hydrogen for diffusion through the mid-electrode and for a reaction with the carbon compound to generate carbon dioxide at the anode;
a cathode;
a source of oxygen for directing the oxygen onto the cathode;
an electrolyte positioned between the mid-electrode and the cathode to establish a reaction wherein hydrogen from the mid-electrode is ionized to produce protons for oxidation at the cathode to produce water; and
an external circuit interconnecting the cathode with the anode for carrying electrons generated by the device as the electrical current in the external circuit.

2. A device as recited in claim 1 wherein the mid-electrode is hydrophobic and is porous.

3. A device as recited in claim 2 wherein the mid-electrode is made of a porous carbon.

4. A device as recited in claim 1 wherein the carbon compound in the mixture is methanol.

5. A device as recited in claim 4 wherein the mixture is alkaline and includes sodium hydroxide (KOH).

6. A device as recited in claim 4 wherein the mixture is acidic and includes sulfuric acid (H₂SO₄).

7. A device as recited in claim 1 wherein the carbon compound in the mixture is ethanol.

8. A device as recited in claim 1 wherein the electrolyte is a Proton Exchange Membrane (PEM).

9. A device as recited in claim 1 further comprising a means for removing carbon dioxide gas through the anode.

10. A device as recited in claim 1 wherein the anode is coated with a catalyst.

11. A device as recited in claim 10 wherein the catalyst is selected from a group consisting of ruthenium (Ru) and platinum (Pt).

12. A device as recited in claim 1 wherein the mixture is alkaline.

13. A device as recited in claim 1 wherein the mixture is acidic.

14. A unit for generating an electrical current which comprises:
an electrolysis cell established by a mid-electrode and an anode;
a hydrogen fuel cell established by the mid-electrode and a cathode;
a means for providing the electrolysis cell with a mixture of water and a carbon compound to produce hydrogen at the mid-electrode and electrons and carbon dioxide at the anode from the mixture;
a means for directing oxygen onto the cathode to oxidize protons generated in the hydrogen fuel cell; and
an external circuit interconnecting the anode with the cathode for carrying electrons generated by the unit as the electrical current in the external circuit.

15. A unit as recited in claim 14 wherein the hydrogen fuel cell includes a Proton Exchange Membrane (PEM) electrolyte positioned between the mid-electrode and the cathode.

16. A unit as recited in claim 14 wherein the carbon compound in the mixture is methanol and the overall unit reaction is: CH₃OH+[3/2]O₂→2H₂O+CO₂.

17. A unit as recited in claim 14 wherein the carbon compound in the mixture is ethanol and the overall unit reaction is: C₂H₅OH+3O₂→3H₂O+2CO₂.

18. A unit as recited in claim 14 wherein the anode is coated with a catalyst, and the catalyst is selected from a group consisting of ruthenium (Ru) and platinum (Pt).

19. A unit for generating an electrical current which comprises:
a hydrophobic, porous mid-electrode having a first side and an opposite second side;
an anode positioned at a first distance from the first side of the mid-electrode to create a gap therebetween;
a means for providing a mixture of water and a carbon compound in the gap to establish an electrolysis cell;
a means to remove carbon dioxide gas through the anode;
a cathode positioned at a second distance from the second side of the mid-electrode;
an electrolyte positioned between the cathode and the second side of the mid-electrode to establish a hydrogen fuel cell;
a source of oxygen for directing oxygen onto the cathode; and
an external circuit interconnecting the anode with the cathode for carrying electrons generated by the unit as the electrical current in the external circuit.

20. A unit as recited in claim 19 wherein an electrolysis reaction at the first side of the mid-electrode provides hydrogen for migration through the hydrophobic pores of the mid-electrode to the hydrogen fuel cell, and provides hydroxide anions for reaction with the carbon compound at the anode to create carbon dioxide and water, along with electrons at the anode for travel through the external circuit.

21. A unit as recited in claim 20 wherein an ionizing reaction at the second side of the mid-electrode provides protons for reaction with oxygen at the cathode to create water.

22. A unit as recited in claim 21 wherein the electrolyte of the hydrogen fuel cell is a Proton Exchange Membrane (PEM).

23. A unit as recited in claim 19 wherein an electrolysis reaction at the first side of the mid-electrode provides hydrogen for migration through the hydrophobic pores of the mid-electrode to the hydrogen fuel cell, and produces protons for migration toward the mid-electrode and electrons at the anode for travel through the external circuit.
